(19) United States
(12) Patent Application Publication
(10) Pub. No.: US 2012/0130926 A1
(43) Pub. Date: May 24, 2012

(54) NETWORK CLASSIFICATION LINK SYSTEM, METHOD, AND COMPUTER RECORDING MEDIUM

(76) Inventors: Chih-Wei HSU, Tainan County (TW); Sheng-Tzong Cheng, Taipei City (TW)

(21) Appl. No.: 12/970,644

(22) Filed: Dec. 16, 2010

(30) Foreign Application Priority Data
Nov. 24, 2010 (TW) 099140544

(51) Int. Cl. G06F 15/18

(52) U.S. Cl. 706/12

(57) ABSTRACT

A network classification link system, method, and computer recording medium are presented. The system includes: an operation interface, for providing an execution item menu and a network sheet; an input unit, for obtaining a first operation signal and a second operation signal to select an operating item and a network connection option corresponding to the first operation signal and the second operation signal respectively; a storage unit, for storing a network connection class, the operating item, and the network connection option; and a processing unit, for performing learning training through the operating item and the network connection option, generating a network classification link model according to the network connection class, the operating item, and the network connection, and judging a use weight of the network classification link model to establish an automatic network link mode.

### CROSS-REFERENCE TO RELATED APPLICATION

This application claims the benefit of Taiwan Patent Application No. 099140544, filed on Nov. 24, 2010, which is hereby incorporated by reference for all purposes as if fully set forth herein.

### BACKGROUND OF THE INVENTION

1. Field of Invention

The present invention relates to a network classification link system, method, and computer recording medium, and more particularly to a network classification link system, method, and computer recording medium capable of performing learning training according to a user operating item and a network connection option.

2. Related Art

Generally speaking, main connection modes of current broadband networks are mainly divided into three connection modes, that is, Point-to-Point Protocol over Ethernet (PPPoE), Dynamic Host Configuration Protocol (DHCP), and Static IP Address. When a user intends to connect an electronic apparatus to a network, a communication protocol between the electronic apparatus and a network access device or a network server must be obtained firstly, so as to enable the electronic apparatus to be connected to the network. Thus, the user has to set a network connection mode manually before connecting to the Internet and using network resources.

However, parameters to be set for different connection modes are different. Unless the user has considerable knowledge and research in the network and can set the connection modes by himself/herself, it is difficult and complicated for an ordinary user unfamiliar with the network to grasp setting manners of various network connection modes. Hence, usually because a user does not know how to set the network connection mode, an error occurs in the setting of the network connection mode so that network resources cannot be used, or a long time is required to research the setting manner, which causes trouble to the user.

Therefore, how to provide a network connection mode that the user can set simply so as to save the time of setting the network connection mode is one of important topics at present.

### SUMMARY OF THE INVENTION

The present invention provides a network classification link system, method, and computer recording medium. According to a network connection class, an operating item, and a network connection, a network classification link model is generated, so as to achieve the purpose of establishing an automatic network link mode through the network classification link model according to the network classification link system, method, and computer recording medium.

The present invention provides a network classification link system, which comprises an operation interface, an input unit, a storage unit, and a processing unit. The operation interface provides an execution item menu and a network sheet; the input unit obtains a first operation signal to select an operating item on the execution item menu corresponding to the first operation signal and inputs a second operation signal to select a network connection option on the network sheet corresponding to the second operation signal; the storage unit stores a network connection class, the operating item, and the network connection option; and the processing unit performs learning training through the operating item and the network connection, generates a network classification link model according to the network connection class, the operating item, and the network connection option, and judges a use weight of the network classification link model to establish an automatic network link mode.

The present invention provides a network classification link method, which is applicable to an electronic apparatus. The electronic apparatus at least comprises a storage module for storing a network connection class. The method comprises the following steps. Firstly, an operation interface having an execution item menu and a network sheet is provided, and then a first operation signal is obtained to select an operating item on the execution item menu corresponding to the first operation signal, and a second operation signal is obtained to select a network connection option on the network sheet corresponding to the second operation signal. Then, the corresponding operating item and network connection option are stored in a storage device, learning training is performed according to the operating item and the network connection option, and a network classification link model is generated according to the network connection class, the operating item, and the network connection. Finally, a use weight of the network classification link model is judged to establish an automatic network link mode.

The present invention further provides a computer recording medium, for being read by an electronic apparatus to execute the network classification link method. The process is as illustrated above, and will not be described herein again.

In an embodiment of the present invention, the network classification link system further comprises a classifier for classifying the network connection option on the network sheet according to parameters and attributes of the network connection option on the network sheet.

In an embodiment of the present invention, the storage unit further stores a network state to provide a network connection strength as a basis of the network classification link model.

In an embodiment of the present invention, the processing unit establishes an attribute sheet and a rule sheet according to the network connection class, the operating item, and the network connection, and introduces the attribute sheet and the rule sheet into a network classification link model algorithm, so as to calculate the use weight of the attribute sheet and the rule sheet according to the first operation signal and the second operation signal.

The present invention adopts a network classification link system, method, and computer recording medium capable of detecting the intention of a user, which deduce an optimal connection manner of the user when performing an operating item in an operation mode of the user such as a network connection class, the operating item, and a network connection option, and provide the operating item and the network connection option to enable the system to perform learning training, so that the system can automatically provide network connection option and establish the network connection manner most suitable for the user.

### BRIEF DESCRIPTION OF THE DRAWINGS

The present invention will become more fully understood from the detailed description given herein below for illustration only, and thus are not limitative of the present invention, and wherein:

FIG. 1 is a schematic block diagram of elements of a network classification link system according to the present invention;

FIG. 2 is a flow chart of steps of a network classification link method according to the present invention;

FIG. 3 is a schematic block diagram according to another embodiment of the present invention; and

FIG. 4 is a flow chart of relevant steps performed between elements in FIG. 3.

### DETAILED DESCRIPTION OF THE INVENTION

In order to make the aforementioned features and advantages of the present invention more comprehensible, embodiments are illustrated in detail hereinafter with reference to the accompanying drawings.

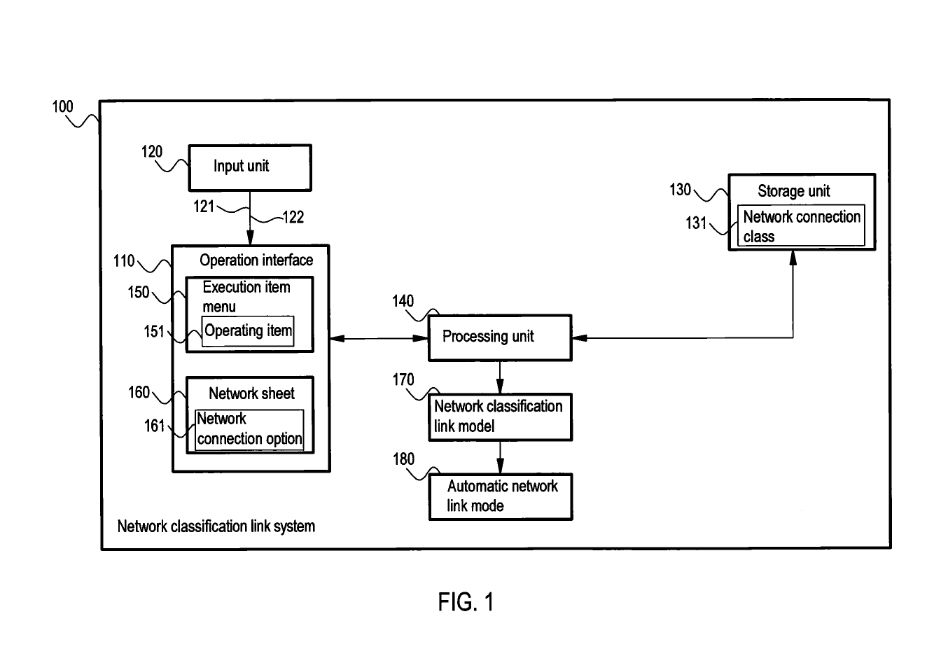

FIG. 1 is a schematic block diagram of elements of a network classification link system according to the present invention. In FIG. 1, a network classification link system 100 includes an operation interface 110, an input unit 120, a storage unit 130, and a processing unit 140. The operation interface 110 provides an execution item menu 150 and a network sheet 160; the input unit 120 obtains a first operation signal 121 to select an operating item 151 on the execution item menu 150 corresponding to the first operation signal 121 and inputs a second operation signal 122 to select a network connection option 161 on the network sheet 160 corresponding to the second operation signal 122; the storage unit 130 stores a network connection class 131, the operating item 151, and the network connection option 161; and the processing unit 140 performs learning training through the operating item 151 and the network connection option 161, generates a network classification link model 170 according to the network connection class 131, the operating item 151, and the network connection option 161, and judges a use weight of the network classification link model 170 to establish an automatic network link mode 180.

In this embodiment, the network classification link system further includes a classifier to classify the network connection option on the network sheet according to parameters and attributes of the network connection option on the network sheet.

In this embodiment, the storage unit further stores a network state to provide a network connection strength as a basis of the network classification link model.

In this embodiment, the processing unit establishes an attribute sheet and a rule sheet according to the network connection class, the operating item, and the network connection option, and introduces the attribute sheet and the rule sheet into a network classification link model algorithm, so as to calculate the use weight of the attribute sheet and the rule sheet according to the first operation signal and the second operation signal.

Still further, the processing unit has a preset value corresponding to the use weight set therein, and the processing unit calculates a number of operation times of the first operation signal and the second operation signal, so as to judge whether the number of operation times exceeds the preset value. Thereby, a judgment result is used as a basis on which the processing unit judges the use weight of the network classification link model to establish the automatic network link mode.

Based on the above, through the system, a network connection mode of a user is retrieved according to a use state of the user, and relevant attributes oriented for dynamic attributes of each device in an ongoing network connection manager, including user sheets, intention retrieval, classification, learning, deduction, and storage, all can be used as factors influencing an automatic connection mode.

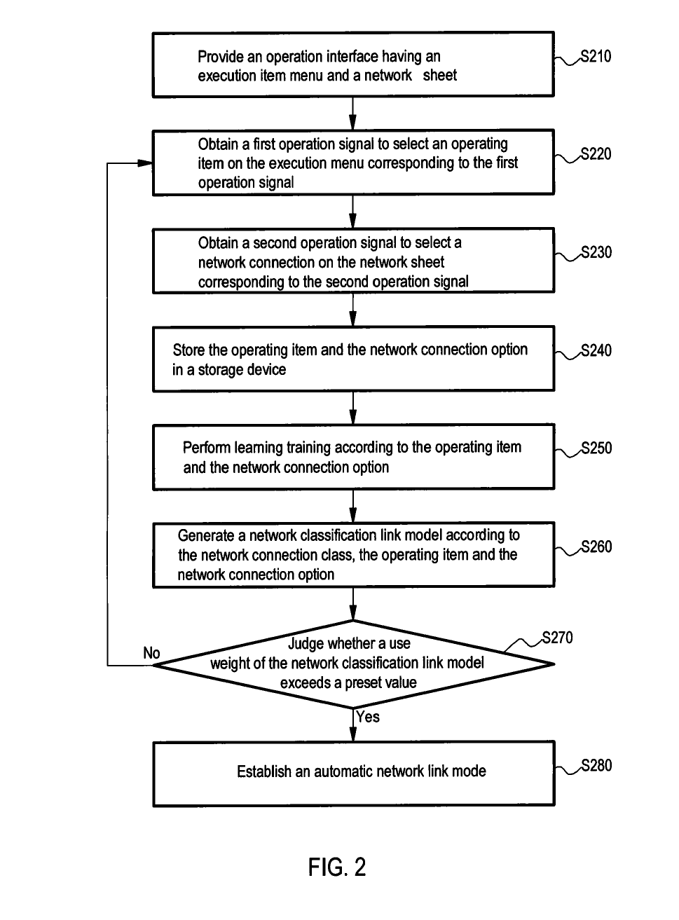

FIG. 2 is a flow chart of steps of a network classification link method according to the present invention. The network classification link method is applicable to an electronic apparatus. The electronic apparatus at least includes a storage module for storing a network connection class. The method includes the following steps.

In Step S210, firstly, an operation interface having an execution item menu and a network sheet is provided.

In this embodiment, the operation interface can provide at least three manners of inputting information. The first manner is that a user selects a priority sequence table. The second manner is that the user directly uses a network device that he/she intends to use without setting any data. The third manner is that the user fills in a user guide sheet.

In Step S220, a first operation signal is obtained to select an operating item on the execution item menu corresponding to the first operation signal, which includes web page browsing, data uploading, data downloading, or E-mail receiving and sending.

In Step S230, a second operation signal is obtained to select a network connection option on the network sheet corresponding to the second operation signal.

In this embodiment, the network connection option can be a wired network connection mode or a wireless network connection mode such as 3G or Wi-Fi.

In this embodiment, while the user utilizes various network connection modes to perform operation, an optimal network connection manner of various operating modes can be obtained.

In Step S240, then, the corresponding operating item and network connection option are stored in a storage device.

In this embodiment, a link relationship between the operating item and the network connection option in the previous step is stored in the storage device, which can be used as a reference basis of a sheet of automatic network connection. Moreover, the storage unit further stores a network state to provide a network connection strength as a reference value of a network classification link model.

In Step S250, learning training is performed according to the operating item and the network connection option.

In Step S260, a network classification link model is generated according to the network connection class, the operating item, and the network connection option.

In this embodiment, an attribute sheet and a rule sheet are established according to the network connection class, the operating item, and the network connection option, and the attribute sheet and the rule sheet are introduced into a network classification link model algorithm, so as to calculate a use weight of the attribute sheet and the rule sheet according to the first operation signal and the second operation signal.

In Step S270, it is judged whether a use weight of the network classification link model reaches a preset value, if not, the process returns to Step S220, and if yes, the next step is performed.

In Step S280, an automatic network link mode is established.

In this embodiment, according to the present invention, while multiple users are using a computer device, a suitable network connection manner is selected among multiple network connections, and with a system having capabilities of input and interaction of the computer device, connection data selected by the users is classified after receiving data, and an explicit sheet is established for the classified data and then stored into the system, so as to provide a menu of the automatic network link mode for the user when performing network connection later for directly establishing the connection.

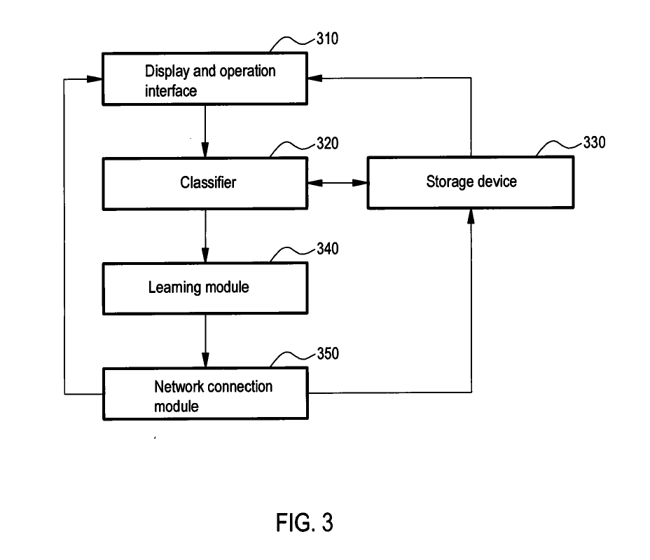

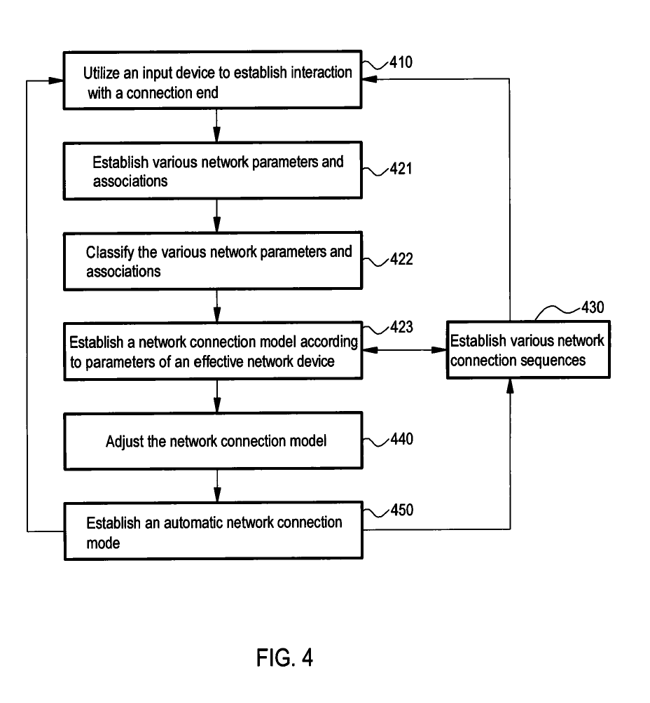

Referring to FIG. 3 and FIG. 4, FIG. 3 is a schematic view of elements according to another embodiment of the present invention, and FIG. 4 is a flow chart of relevant steps performed between the elements in FIG. 3.

In the step process in FIG. 4, the main step is to firstly utilize an input device to establish interaction with a connection end (Step S410), and this step is executed on a display and operation interface 310 in FIG. 3. Then, the following three steps are executed in a classifier 320 in FIG. 3. Various network parameters and associations are established (Step S421), the various network parameters and associations are classified (Step S422), and a network connection model is established according to parameters of an effective network device (Step S423). Then, the network connection model is transferred into a learning module 340, so as to adjust the network connection model (Step S440), and meanwhile, the network connection model established in the classifier 320 is also stored in a storage device 330 to establish various network connection sequences (Step S430). Following Step S440, an automatic network connection mode is established in a network connection module 350 for the adjusted network connection model (Step S450).

In view of the above, the present invention can be applied to an electronic device such as an embedded system, a mobile device, a mini notebook computer, or a smart agent. The present invention emphasizes that, in the procedure of interacting with a user, through known parameter setting, a system provides a network connection between an electronic device of the user and a remote end according to a set priority sequence. Compared with the prior art, the present invention has the following characteristics.

(1) Although many users execute network connection in different operating modes simultaneously, this system is also capable of recording the data one by one, which cannot be achieved in the prior art.

(2) After the network connection is performed every time, the system can predict a connection manner for a subsequent operating mode so as to provide an automatic connection sheet.

(3) This system performs learning training according to an operating item and a network connection option, so as to generate a network classification link model and further establish an automatic network connection mode.

Although the present invention has been described above through the foregoing embodiments, they are not intended to limit the present invention. Equivalent replacements of variations and modifications made by persons skilled in the art without departing from the spirit and the scope of the present invention still fall within the protection scope of the present invention.

What is claimed is:

1. A network classification link system, applicable to an electronic apparatus, comprising:
an operation interface, for providing an execution item menu and a network sheet;
an input unit, for obtaining a first operation signal to select an operating item on the execution item menu corresponding to the first operation signal and inputting a second operation signal to select a network connection option on the network sheet corresponding to the second operation signal;
a storage unit, for storing a network connection class, the operating item, and the network connection option; and
a processing unit, for performing learning training through the operating item and the network connection, generating a network classification link model according to the network connection class, the operating item, and the network connection option, and judging a use weight of the network classification link model to establish an automatic network link mode.

2. The network classification link system according to claim 1, wherein the electronic apparatus is one of an embedded system, a mobile device, a mini notebook computer, and a smart agent.

3. The network classification link system according to claim 1, further comprising a classifier, for classifying the network connection option on the network sheet according to parameters and attributes of the network connection option on the network sheet.

4. The network classification link system according to claim 1, wherein the storage unit further stores a network state to provide a network connection strength as a basis of the network classification link model.

5. The network classification link system according to claim 1, wherein the processing unit has a preset value corresponding to the use weight set therein.

6. The network classification link system according to claim 5, wherein the processing unit calculates a number of operation times of the first operation signal and the second operation signal, so as to judge whether the number of operation times exceeds the preset value.

7. The network classification link system according to claim 1, wherein the processing unit establishes an attribute sheet and a rule sheet according to the network connection class, the operating item, and the network connection.

8. The network classification link system according to claim 7, wherein the processing unit introduces the attribute sheet and the rule sheet into a network classification link model algorithm, so as to calculate the use weight of the attribute sheet and the rule sheet according to the first operation signal and the second operation signal.

9. The network classification link system according to claim 1, wherein the execution item menu comprises an operating item of web page browsing, data uploading, data downloading, or E-mail receiving and sending.

10. The network classification link system according to claim 1, wherein the network connection option is a wired network connection mode or 3G, Wi-Fi, or other wireless network connection modes.

11. A network classification link method, applicable to an electronic apparatus, wherein the electronic apparatus at least comprises a storage module for storing a network connection class, the method comprising:
providing an operation interface, wherein the operation interface has an execution item menu and a network sheet;
obtaining a first operation signal to select an operating item on the execution item menu corresponding to the first operation signal;
obtaining a second operation signal to select a network connection option on the network sheet corresponding to the second operation signal;
storing the corresponding operating item and network connection option in a storage device;
performing learning training according to the operating item and the network connection option;
generating a network classification link model according to the network connection class, the operating item, and the network connection option;
judging a use weight of the network classification link model; and
establishing an automatic network link mode.

12. The network classification link method according to claim 11, wherein the electronic apparatus is one of an embedded system, a mobile device, a mini notebook computer, and a smart agent.

13. The network classification link method according to claim 11, further comprising a network connection option step, comprising:
establishing a classifier; and
classifying the network connection option according to parameters and attributes of the network connection option on the network sheet.

14. The network classification link method according to claim 11, wherein the storage unit further stores a network state to provide a network connection strength as a basis of the network classification link model.

15. The network classification link method according to claim 11, wherein the step of generating the network classification link model further comprises:
establishing an attribute sheet and a rule sheet according to the network connection class, the operating item, and the network connection;
introducing the attribute sheet and the rule sheet into a network classification link model algorithm; and
calculating the use weight of the attribute sheet and the rule sheet according to the first operation signal and the second operation signal.

16. The network classification link method according to claim 15, wherein in the step of judging the use weight of the network classification link model, a preset value corresponding to the use weight is preset.

17. The network classification link method according to claim 15, wherein the processing unit calculates a number of operation times of the first operation signal and the second operation signal, and judges whether the number of operation times exceeds the preset value.

18. The network classification link method according to claim 11, wherein the execution item menu comprises an operating item of web page browsing, data uploading, data downloading, or E-mail receiving and sending.

19. The network classification link method according to claim 11, wherein the network connection option is a wired network connection mode or 3G, Wi-Fi, or other wireless network connection modes.

20. A network classification link computer recording medium, for being recorded by an electronic apparatus and executing a network classification link method, wherein the electronic apparatus at least comprises a storage module for storing a network connection class, and the method comprises:
providing an operation interface, wherein the operation interface has an execution item menu and a network sheet;
obtaining a first operation signal to select an operating item on the execution item menu corresponding to the first operation signal;
obtaining a second operation signal to select a network connection option on the network sheet corresponding to the second operation signal; storing the operating item and the network connection option in a storage device correspondingly;
performing learning training according to the operating item and the network connection option;
generating a network classification link model according to the network connection class, the operating item, and the network connection;
judging a use weight of the network classification link model; and
establishing an automatic network link mode.
